(19) United States
(12) Patent Application Publication
(10) Pub. No.: US 2015/0058752 A1
(43) Pub. Date: Feb. 26, 2015

(54) DAILY TASK TOOLS THAT INTERFACE WITH BACKEND SYSTEMS

(71) Applicants: Ingrid Bernaudin, Palo Alto, CA (US); Michael Dandan, San Mateo, CA (US); Steve Zyszkiewicz, San Bruno, CA (US); Frank Wang, Santa Clara, CA (US); Mei Yu, Palo Alto, CA (US); Vidya Viswanath, San Jose, CA (US)

(72) Inventors: Ingrid Bernaudin, Palo Alto, CA (US); Michael Dandan, San Mateo, CA (US); Steve Zyszkiewicz, San Bruno, CA (US); Frank Wang, Santa Clara, CA (US); Mei Yu, Palo Alto, CA (US); Vidya Viswanath, San Jose, CA (US)

(73) Assignee: SUCCESSFACTORS, INC., South San Francisco, US (US)

(21) Appl. No.: 14/032,064

(22) Filed: Sep. 19, 2013

(30) Foreign Application Priority Data
Aug. 22, 2013 (CN) PCT/CN2013/082083

(51) Int. Cl. H04L 29/06; G06F 3/0488; G06F 3/0482

(52) U.S. Cl. CPC H04L 65/403; G06F 3/0482; G06F 3/0488
USPC 715/753

(57) ABSTRACT

In one embodiment, an improved computer based daily task tool is provided that interfaces with backend systems to leverage the stored information and/or processing capabilities of backend systems to provide better information and more effective task tool functionality.

### RELATED APPLICATIONS

This application is a continuation of, and claims priority to, the following commonly owned international patent application, which is hereby incorporated by reference herein in its entirety:

International Application No. PCT/CN2013/082083, filed on Aug. 22, 2013, and titled “IMPROVED DAILY TASK TOOLS THAT INTERFACE WITH BACKEND SYSTEMS.”

### BACKGROUND

The invention disclosed herein relates generally to computing and data processing. More specifically, the invention relates to improvements in computer based daily task tools.

Unless otherwise indicated herein, the approaches described in this section are not prior art to the claims in this application and are not admitted to be prior art by inclusion in this section.

Computer based daily task tools such as email, calendar and notes, have become easily accessible and prevalent in modern life. Further, when provided on mobile devices such as Personal Digital Assistants (PDAs), smartphones, tablet computers, and other portable devices, such daily task tools also provide an important mechanism for providing information to a user wherever the user is.

Advances in technology have made it possible for increasingly large amounts of data to be transmitted over computer networks. These improvements have produced cloud based services and systems that can provide users of computer based tools with access to distributed systems containing large data storage structures and sophisticated processing resources.

Enterprises have an interest in providing their employees with efficient and easily usable solutions for accessing data and resources in an enterprise's backend systems. Providing better mechanisms for interfacing with such backend systems has the potential to increase the flow of information across, and the speed with which information can be used throughout, an enterprise, among other things, thereby potentially providing significant gains in employee productivity.

### SUMMARY

Various embodiments of the present disclosure provide for improved computer based daily task tools that interface with backend systems containing human resources and other employee related information, as well as processing resources, to provide better information and/or task tool functionality to users of the improved computer based daily task tools. For example, in one embodiment, an improved computer based daily task tool automatically incorporates information from backend databases into information displayed in a graphical user interface of the daily task tool, for example, a computer based calendar. Other embodiments may improve a first daily task tool (e.g., a tool for keeping track of discussions topics between the user and another person) by obtaining information from a second daily task took (e.g., a computer based calendar).

The following detailed description and accompanying drawings provide a better understanding of the nature and advantages of the present invention.

### BRIEF DESCRIPTION OF THE DRAWINGS

The invention is illustrated in the figures of the accompanying drawings which are meant to be exemplary and not limiting, in which like references refer to like or corresponding parts, and in which:

FIG. 1 illustrates a block diagram presenting a network topology in which a mobile device retrieves information from backend enterprise databases to display to a user in an improved calendar daily task tool utilized on a mobile device according to one embodiment of the present invention;

FIGS. 2A-2B show a flow diagram presenting a method performed by an improved calendar daily task tool according to one embodiment of the present invention;

FIG. 3 shows a flow diagram presenting a method performed by a mobile server of an enterprise network to support an improved daily task tool provided in a mobile device according to one embodiment of the present invention;

FIG. 4 shows a diagrammatic representation of a secure data store provided in a mobile device according to one embodiment of the present invention;

FIG. 5 shows a flow diagram illustrating a method performed by an enterprise server to process events on a user's calendar to determine auto populated entries according to one embodiment of the present invention;

FIGS. 6A-6D shows a diagrammatic representation of stages in the process described in FIG. 7 according to one embodiment of the present invention;

FIG. 7 shows a screenshot of a user interface of a mobile device displaying a list view of the events in a user's calendar according to one embodiment of the present invention;

FIG. 8 shows a screenshot of a user interface of a mobile device displaying a detailed view of a selected meeting in a user's calendar according to one embodiment of the present invention;

FIG. 9 shows a screenshot of a user interface of a mobile device displaying a detailed view of a selected meeting in a user's calendar which includes touchbase information according to one embodiment of the present invention;

FIG. 10 shows a screenshot of a user interface of a mobile device displaying a touchbase screen according to one embodiment of the present invention; and

FIG. 11 illustrates hardware of a special purpose computing machine configured to perform a process according to various embodiments of the present invention.

### DETAILED DESCRIPTION

Described herein are systems and techniques for improved computer based daily task tools, such as calendar and email, that interface with backend systems containing human resources and other employee related information, as well as processing resources. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

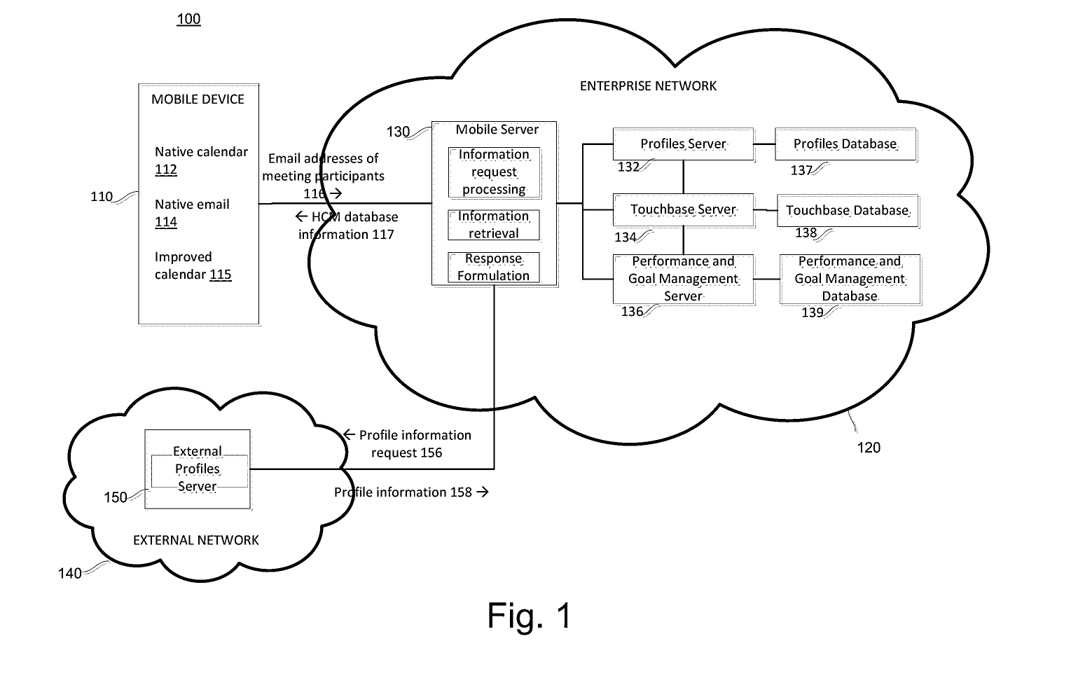

Embodiments of a method and system for improved computer based daily task tools that interface with backend systems, in accordance with the present invention, are described herein with reference to the drawings in FIGS. 1 through 11.

Modern businesses generally provide their employees with computer based daily task tools. These can include email, calendar and notes, as well as other computer based tools, such as a computer based tool for keeping track of topics to be discussed in the future with another person (for ease of reference, the latter tool with be referred to as a touchbase tool herein). An exemplary tool for keeping track of discussion topics between two individuals is Touchbase, a solution available from SuccessFactors, a SAP AG company based in South San Francisco.

Such computer based daily task tools are an integral part of daily life for many people, and frequently are accessed numerous times a day.

Information stored in a company's backend databases systems is frequently underutilized because the information is typically not easily accessible. In some cases, the information stored in backend systems is not made available to general employees at all, or, if made available, the tools provided for accessing the information are cumbersome or not familiar to most employees.

An example of information stored in backend databases is human resources information. Modern business typically maintain a large amount of human resources and other information relating to their employees. For example, a Human Capital Management (HCM) system may contain profiles of each employee, for example, including a photograph of the employee, the employee's job title, a description of the employee's job responsibilities, who the employee reports to, the employee's location, contact information, etc.

Various embodiments of the present disclosure provide systems and techniques for connecting backend systems to daily task tools, such as email and calendar, to make an employee's daily tasks easier to perform. In one example embodiment, when a user opens her improved calendar tool, a scrolled list of the meetings in a user's calendar is provided which identifies each meeting by its subject, location, date, and time—the typical information provided in a calendar. When a user selects a meeting in the list, a screen is opened that provides more detailed information, drawn from a company's backend databases, regarding the selected meeting and that meeting's participants. For example, the information might specify an agenda for the meeting, as well as present a photograph of each of the meeting participants and their job titles. Further, an option might be provided to access a profile page for any of the participants to the meeting. Additionally, where the meeting is a one-to-one meeting, reminders of topics, previously entered into a touchbase system, for discussion between the user and the other meeting participating, might also be displayed.

Features of the present disclosure include automatically incorporating information from backend databases into daily task tools to present such information to a user in a more easily accessible and usable format. Additional features include improving a first daily task tool by retrieving information from a second daily task tool (e.g., events appearing on a computer based calendar), and processing that information in a backend system to make an improvement to the first daily task tool.

Advantages of the present disclosure include, for example, saving employees time by removing the need to look up information about meeting participants when employees are invited to meetings where they do not know all the participants. Various embodiments can also, for example, be useful in proposing an appropriate time for a meeting when meeting participants are located in different time zones by making information regarding the meeting participants' locations readily available. In other embodiments, described further below, better auto-population suggestions can be made regarding people with whom a user may wish to create touchbase topics. On a more general level, various embodiments provide time savings and promote greater efficiency, by leveraging the stored information and processing capabilities of backend systems to provide better information, and more effective task tool functionality, to users of daily task tools.

As noted above, various embodiments of the present disclosure provide systems and techniques for improved computer based daily task tools (e.g., a computer based calendar) that interface with backend systems containing human resources and other employee information, as well as processing resources, to provide better information and/or task tool functionality. Embodiments for improved daily task tools may be implemented in a wide variety of networking contexts. Turning to FIG. 1, a network topology comprising hardware and software components configured according to one embodiment of the present invention is illustrated. The network topology presented comprises a mobile device 110, connected to a network 120, which may, for example, be a private network of a business or enterprise. Network 120 may include a mobile server 130, as well as one or more other servers 132, 134 and 136 with particular enterprise functions. Network 120 may also include one or more databases 137, 138 and 130, which hold data relevant to the business's operations.

In the illustrated embodiment, mobile device 110 comes equipped with a native calendar tool 112, as well as a native email tool 114. Mobile device 110 also includes an improved daily task tool in the form of an improved calendar 115, also referred to herein as a My Meetings tool, that has the ability to obtain and display information in an interactive graphical user interface of mobile device 110.

In other embodiments, information 117, which was retrieved from backend databases and sent by mobile server 130 to mobile device 110 in response to an information request, may be communicated to a user using a natural language voice interface of mobile device 110.

In some embodiments, improved calendar 115 may be implemented on mobile device 110 in conjunction with execution of certain application software downloaded to mobile device 110 as part of a cloud-based solution provided by an enterprise, the enterpreise associated with network 120. Embodiments of the application software may be integrated as a component of one or more server applications or it may be a stand-alone program executing on mobile server 130.

In some embodiments, improved calendar 115 is provided as a cloud-based software solutions using the Software as a service (SAAS) model.

Improved calendar 115 on mobile device 110, when used in conjunction with mobile server 130 and possibly other servers 132, 134 and 136 and/or databases 137, 138 and 139 in network 120, may have the capability to associate information stored in backend databases 137, 138 and 139, for example, human resources profile information regarding employees, with events in a user's native calendar 112. Matching of information in backend databases with events in a native calendar provides for the possibility of an enhanced user experience of a calendar, in which better information, as well as better task tool functionality, may be provided to the user.

It should be understood that the configurations of servers and databases described herein are merely exemplary and that backend data may be stored in any of a variety of configurations. Enterprise network 120 may be organized using any of a variety of well-known mechanisms for accessing and storing data of an enterprise. It may include servers and databases as well as any other suitable modules for improving daily task tools.

In the embodiment illustrated in FIG. 1, mobile server 130 acts as a gateway through which mobile devices can access the resources contained in network 120. According to one embodiment, mobile server 130 may comprise a single server with associated data stores.

In alternative embodiments, mobile server 130 may correspond to multiple distributed servers and data stores, which, for example, may be part of a cloud network, and which together perform the functions described herein. Embodiments of a distributed system may be implemented in a wide variety of network environments. For example, in the embodiment illustrated in FIG. 1, enterprise network 110 may be organized such that separate servers 132, 134, 136 act as intermediaries between mobile server 130 and backend database 137, 138 and 139 of a Human Capital Management (HCM) system of the enterprise.

As shown in the illustrated embodiment, enterprise network 120 may include a profiles server 132 for accessing information in a profiles database 137, a touchbase server 134 for accessing information in a touchbase database 138, and a performance and goal management server 132 for accessing information in a performance and goal management database 139. Profiles database 137 may include profile information, such as employee identification number, photograph, job title, job location, supervisor, direct reports, etc., pertaining to the employees of an enterprise. Touchbase database 138 may include information pertaining to topics about which two employees of a company wish to “touch base”—that is, to further discuss or follow up on, among other things. Such touchbase data might include text of the topic itself, as well as another text field, and audio or image files, which a user has associated with the topic. The touchbase system may also enable a user to indicate when a topic has been completed, or when it has been postponed, for example. The performance and goal management database database 139 may include information pertaining to goals set for each employee, as well as data tracking their performance while they are at the company.

Mobile server 130 may include an information request processing module, an information retrieval module, and a response formulation module, which operate together to process requests for data received by mobile device 110 and return requested information.

Mobile server 130 may be accessed by mobile device 110 through a wireless connection to a wide area network such as the Internet, a cellular network or any of a variety of other networks. Embodiments of the above network topology may be implemented in a wide variety of network environments including, for example, TCP/IP-based networks, telecommunications networks, and wireless networks, etc., or a combination of such networks

Mobile server 130 may be connected to a second network 140. Network 140 may be a third party private network operated by a third party service provider which gathers information pertaining to business profiles of individuals. An example of a company that provides such services is LinkedIn based in Mountain View, Calif. Network 140 may include a profiles server 150. Where mobile server 130 is unable to identify a meeting participant in databases of enterprise network 120, mobile server 130 may try to retrieve information about such individual(s) through profiles server 150 of network 140.

Various embodiments of the present disclosure are discussed in terms of mobile devices, and specifically in reference to the iPad available from Apple Inc. of Cupertino, Calif., but that should not be understood as limiting the invention.

Mobile devices are a useful platform for improved daily task tools because they are portable and are usually capable of connecting wirelessly to wide area networks, such as the Internet. With increasing improvements to data transmission speeds, such networking capabilities allow mobile devices to transmit significant amounts of data to and receive data from server(s) at a remote locations, thus providing mobile devices with the ability to provide users with access to large amounts of data and powerful computing environments in the context of easily portable and prevalent devices.

However, various other embodiments may be implemented on desk top or other types of systems Implementations are contemplated in which improved calendar 115 may be implemented on a variety of different devices and device platforms, e.g., a personal digital assistant (PDA), smartphone, a tablet computer, a laptop computer, a desktop computer etc., and based on Apple iOS, Windows OS, and Android OS, or a variety of other mobile and desktop Operating Systems

In some embodiments, application software for improved calendar 115 may be written using tools Apple Inc. provides software developers to use in creating programs for its products. For example, Apple's Xcode which includes an OS X and iOS Software Development Kit (SDK). Apple's SDK includes UIKit and Foundation frameworks, as well as other frameworks like EventKit, whose use in various embodiments is further discussed below. In other embodiments, the application software may be written using another programming platform.

Further, in some embodiments, improved calendar 115 may be implemented as a free standing tool. In other embodiments, improved calendar 115 may be implemented by building upon, and expanding the features of, tools such as native email 112 and native calendar 114 already provided on mobile device 110.

Mobile device 110 may have network interfaces for communicating with other devices through networked connections. It may also have a visual display with a graphical user interface for providing to a user. The visual display may convey information in the form of text, images, links, etc. Mobile device 110 may also have an interactive touch interface for receiving user input.

Mobile device 110 may be operable to download data regarding the contents of a user's calendar. It may also be operable to parse the data to retrieve information about the meetings, such as data, time and location of a meeting, as well as email addresses of each of the meeting participants.

A user's interaction with a local application, web site or web-based application or service (e.g., providing calendar services) may be accomplished using any of a variety of well-known mechanism. It should be understood that methods of accessing data in a user's calendar described herein are merely exemplary and that calendar data may be retrieved in many other ways.

As described above, various embodiments of the present disclosure provide a system or method for improving a computer based calendar by retrieving information regarding participants in a meeting from backend databases and displaying that information in an interactive graphical user interface of mobile device 110.

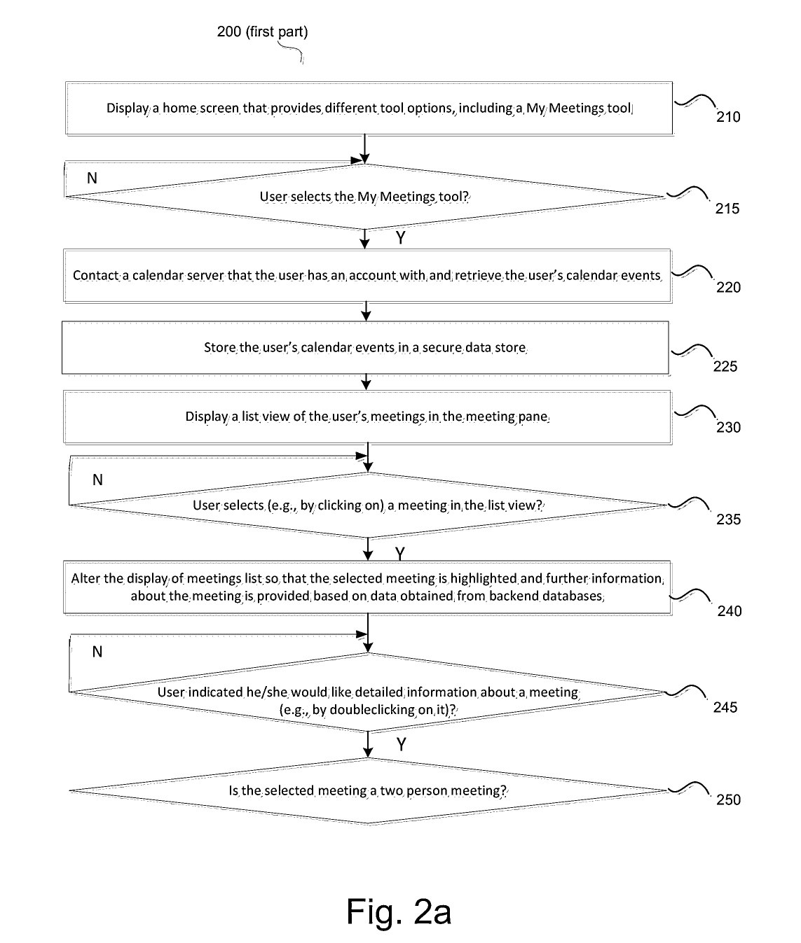

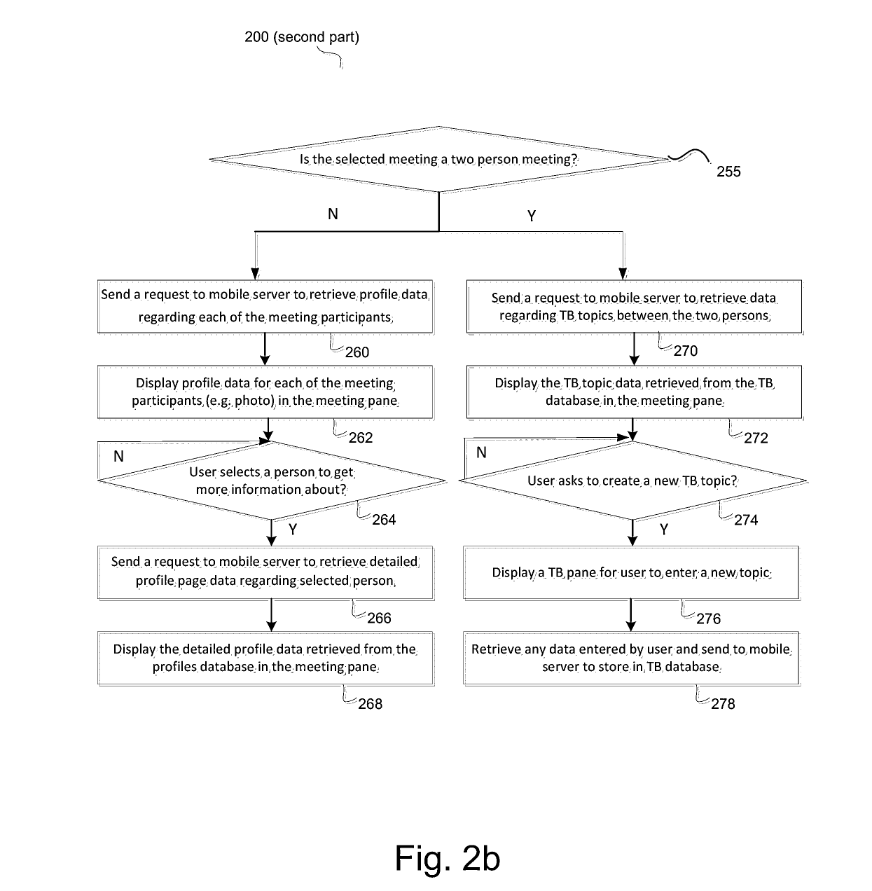

FIGS. 2A-2B show a flow diagram illustrating a method performed by an improved calendar procedure 200 (which will also be referred to as the My Meetings procedure) according to one embodiment. The specific example of a mobile device depicted in FIG. 1 will be referenced for purposes of explanation, but it will be understood that, in practice, mobile devices performing the below process need not have all of the features, or the same network context, as mobile device 110.

In one exemplary implementation, improved calendar procedure 200 is implemented on an Apple iPad, and the improved calendar tool is referred to as “My Meetings”.

In FIGS. 2A and 2B, the improved calendar (My Meetings) tool is described with respect to use by a single user on a single mobile device 110. It will be understood that an improved calendar may take different forms, and may be implemented with respect to any number of different devices (including desk top devices such as desk top computers) and users, in a diverse cellular and/or computer network as described further herein.

In one example, to initiate the improved calendar procedure 200, a user may open a tool comprising a suite of business tools, which includes the improved calendar tool. An exemplary embodiment of such a suite of business tools is the BizX mobile application available from SuccessFactors of South San Francisco, Calif.

Opening the suite of business tools may involve a log in procedure in which the user sends a message including a passcode, authenticating himself to enterprise network 120 as someone authorized to access data in enterprise network 120. When confirmation is received from enterprise network 120 that the user has been authenticated, improved calendar 115 may be made available on mobile device 110. FIGS. 2A-2B illustrates some of the steps that might follow in one embodiment of the present disclosure.

Initially, in 210, a user may elect to open a My Meetings tool from a home screen the suite of business tools. The home screen may be displayed on graphical user interface of mobile device 110.

It will be understood that, in practice, the My Meetings process may be triggered in a number of different ways. For example, he My Meetings tool may also be automatically presented to the user in the display of the mobile device after the user turns the mobile device on or after the user opens the suite of business tools containing the improved calendar. In some embodiments, the user may also select the My Meetings tool at any time as a selectable mobile application.

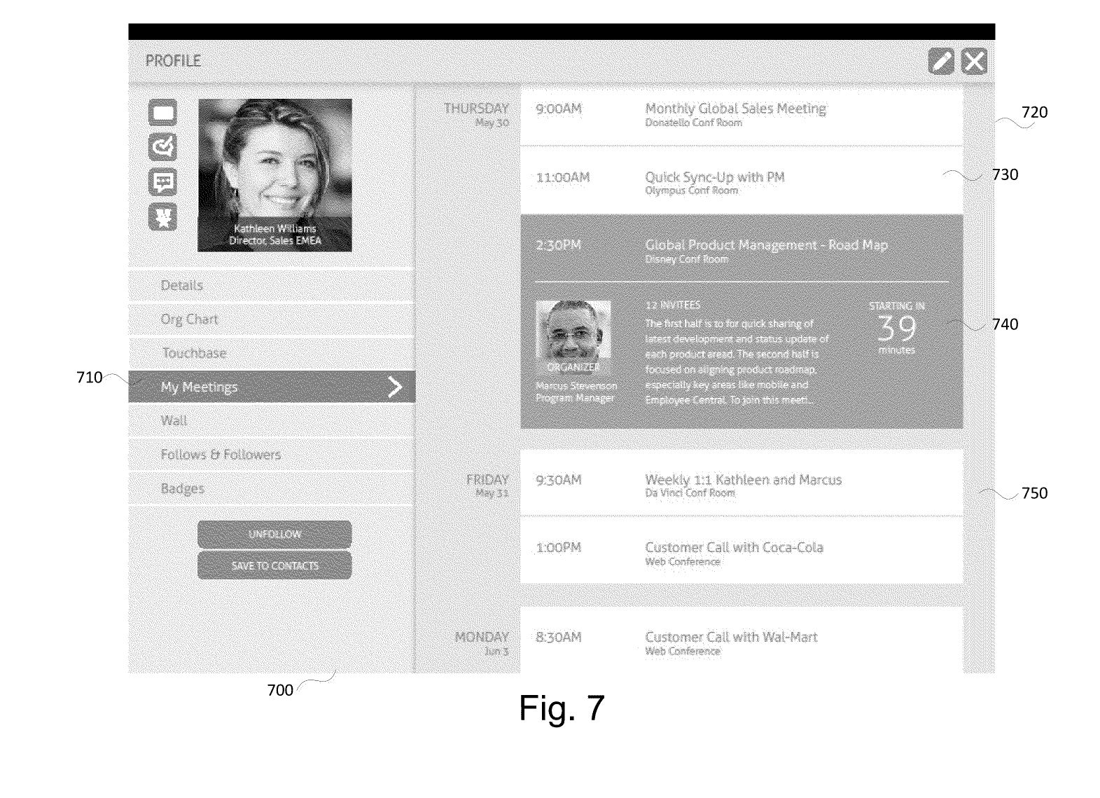

As one example, FIG. 7 shows a screen 700 that might be displayed on mobile device 110. In screen 800, in the left hand pane, a My Meetings option 710 is presented as one of a set of daily task tools in accordance with one embodiment of the present disclosure. A user may select the My Meetings tool 710 by manipulating the My Meetings component in the graphical user interface in a variety of different ways, for example, by double clicking on the My Meetings option 710.

Referring back to FIG. 2A, in 215, My Meetings procedure 200 may determine whether the My Meetings option has been selected by the user. My Meetings procedure 200 may continue to wait for selection of the My Meetings tool by the user of mobile device 110 in operation 215.

When the My Meetings option is selected, procedure 200 may open a pane in a graphical user interface of mobile device 110, the pane showing a list view of a subset of the events in the user's calendar. Providing a view of the events in the user's calendar involves the following steps.

In 220, when a user selects the My Meetings option, My Meetings procedure 200 may contact a Microsoft Exchange server and/or other server(s) or services with which the user holds calendar accounts, to retrieve information about events appearing on the user's calendar(s).

Exchange Server is an e-mail-based collaborative communications server for businesses, available from Microsoft Corporation based in Redmond, Wash. It can be used to store calendar events of a user. Other exemplary services which provide calendar functionality are Google calendar, a web based calendar service available from Google Inc., and iCloud, a cloud service provided by Apple Inc. that can store calendars, among other things. The calendar information for the user may be held in one or more databases. Calendar information may also be stored for the user on another type of service or application, and the calendar information may be accessible by mobile device 110 through its registration with such other services.

Improved calendar tool 115 may draw from and use features already built into mobile device 110. For example, according to some embodiments, loading calendar data into mobile device 110 may be performed using a procedure that mobile device 110 is already operable to perform in support of its native calendar tool 112.

A variety of different mechanisms may be used to obtain a user's calendar data from Exchange Server and/or other calendar servers and services. In one embodiment, the EventKit framework provided by Apple Inc. as part of its iOS Software Development Kit (SDK) (which Apple Inc. provides to software developers to develop applications for Apple products) may be used. The EventKit framework provides a way to access the Calendars, Calendar Events, and Reminders data that a calendar database stores.

In 225, My Meetings procedure 200 processes and/or stores calendar data received from the Exchange Server. The calendar data may be parsed to identify each event in the user's calendar. The event data may be stored/used in a variety of different ways.

In some embodiments, the data may be associated with event objects, and those objects may be associated with cells, for example, of a UITableView or CollectionsView, the cells then ordered to provide for display of the data items in a predefined way. Further, given the confidential nature of information that may be accessed in backend databases, in some embodiments, further security features are provided.

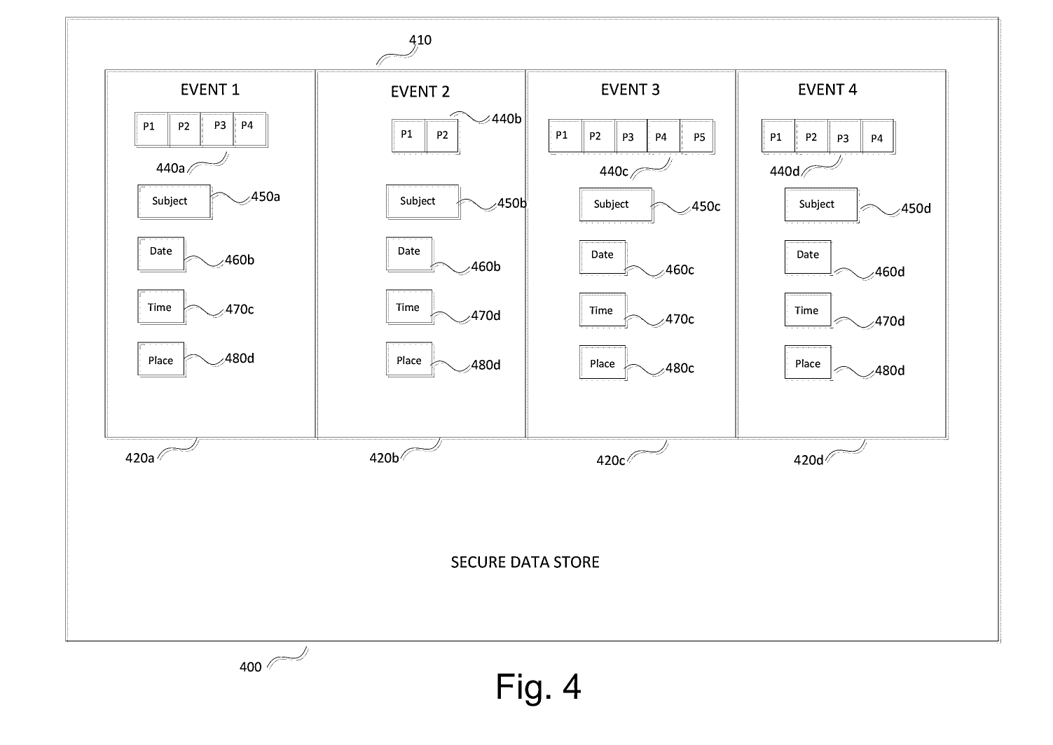

In some embodiments, discussed further below with regard to FIG. 4, calendar data retrieved from Exchange Server or another calendar server or service is copied and stored in a secure data store created for this purpose on mobile device 110. An exemplary secure data store is illustrated in FIG. 4, and described in further detail below.

In some embodiments, the operating system (OS) of mobile device 110 (e.g., in the case of an Apple iPad, the device's iOS) may maintain a communication link with the Exchange Server or other calendar server or service, to retrieve updates regarding the user's calendar, such as events newly added to the calendar while improved calendar 115 is open. When a new event is added to the user's calendar(s), the event may be retrieved by My Meetings procedure 200 and, for example, associated with an object and the object added to an array of event objects stored in the secure data store.

In 230, My Meetings procedure 200 displays a list view of meetings in the user's calendar in a meetings pane of a screen displayed in mobile device 110's graphical user interface. In some embodiments, the list view may include for each of the set of calendar events currently visible in the view, a rectangular box (e.g., element 730 of FIG. 7) containing text indicating the time, subject matter, and location of the corresponding meeting. A scroll bar may be made available in the graphical user interface, which can be used to “scroll” the list to display events farther in the past or farther in the future than the group of events currently visible in the view.

An illustration of an exemplary list view of a user's calendar events is shown in FIG. 7. FIG. 7 shows a graphical user interface screen 700 displaying, on the right hand side, a meetings pane 720 that includes a list view of a user's calendar events. As shown in FIG. 7, the list view includes a scroll bar 750 located to the right of the list of events. Scroll bar 750 may be manipulated by the user using a mouse or other user interface device, to show different calendar events in the display. For example, the scroll bar may be pulled to the top of screen 700 to display events further in the past, and the scroll bar may be pulled to the bottom of the screen 700 to display events farther in future.

As discussed further below, in connection with FIG. 4, the scroll bar may also be used by My Meetings procedure 200 in connection with solving a challenge associated with copying events data retrieved from an Exchange Server or other calendar server or service, into objects in a secure data store.

In 235, it is determined whether a user has made a selection of an event in the events list. A selection may be made, for example, by a user clicking on an event with her mouse. My Meetings procedure 200 may continue to wait for selection of an event by the user in operation 235

In 240, after an event has been selected, My Meetings procedure 200 may replace the original list view of the user's calendar events with a new list view that highlights the selected event and provides further information regarding the selected event. FIG. 7 illustrates such a new list view in which a selected event 740 is highlighted. As shown in FIG. 7, selected event 740 is presented in a darker color than the other events in the list view, in order to highlight the event. Further, the information regarding the event presented in the screen includes—in addition to the time, place and subject matter of the meeting—name, title, and a photograph of the meeting organizer, as well as the number of invitees, and a first part of an agenda for the meeting.

In various embodiments, the additional information described above regarding event 740, which is presented in the GUI, is not stored in Exchange Server or in other calendar servers and services. Obtaining such information requires accessing information in a backend database of enterprise network 120.

In some embodiments, in order to obtain the additional information, mobile device 110 may send a request to mobile server 130 asking, for example, for profile information (e.g., the job title and a photograph) for the meeting organizer. The meeting organizer may be identified by his email address in the request. Such email address may be parsed from the retrieved calendar data. In some embodiments, email addresses and not names are used to identify meeting participants in sending requests to enterprise network 120 asking for profile information because the retrieved calendar may only have accurate email addresses.

In some embodiments, the request for information may take the form of an API call to mobile server 130 in enterprise network 120. In response, mobile server 130 may send a data request to profiles server 132 to obtain profile information from profiles database 137 relating to the meeting organizer. Once mobile server 130 receives the information, it forwards it to mobile device 110.

In some embodiments, as noted above, API calls may be used as part of the process for retrieving data from backend databases. Some possible API calls that may be used as part of this process are the following:
User Search—takes email addresses and gives back profile identifiers (IDs) /api/v3/usersearch
Fetch Avatar—takes a profile ID and gives back an image of the associated employee /api/v2/profiles/%@/thumb?max_x=110&max_y=110
User Details—takes profile ID and gives back name and job title of the associated employee
/api/v3/profiles/%@?with_background_photo=true&query_badge_feature=true
Org Chart Search—takes profile id, gives back an organizational chart api/v4/profiles/%@/org org chart search

In some embodiments, once mobile device 110 has received requested data regarding a selected calendar event, mobile device 110 may copy the data into an event data object associated with the selected event in the events data store. Mobile device 110 may also add the information to the collections view, table view, or whatever other view is being used to display information in the graphical user interface.

In 245, it is determined whether a user has requested more detailed information regarding an event (beyond that displayed in the highlighted view). Such selection may be made, for example, by a user double clicking with her mouse on an event in the new meetings list view illustrated in FIG. 7. While My Meetings procedure 200 continues to wait for such a selection of an event to be made, it continues to display the new list view of the user's calendar events illustrated in FIG. 7, in operation 245.

When the user has made a selection requesting more detailed information regarding an event (beyond that displayed in the highlighted view), My Meetings procedure 200 may replace the original screen displayed in the GUI with a new screen focusing on the selected meeting. This may involve a few steps.

In 250, it may be determined whether the selected meeting involves more than two participants. Where the selected meeting involves three or more persons, a first version of a My Meetings detailed view is provided which does not include touchbase information, but does display photographs of the meeting participants along with job titles and names—as well as the meeting information displayed in the highlighted list view described above.

In the alternative, if the selected meeting is one that involves only two participants, in addition to the above information, touchbase information concerning topics to be discussed between the parties (e.g., such topics previously entered by the user or the other meeting participating, and stored in a touchbase database of enterprise network 120) may also be displayed.

Specifically, according to some embodiments, if the meeting involves more than two participants, in operation 260, My Meetings procedure 200 may send a request for data (e.g., an API call) to mobile server 130 in enterprise network 120, for example, asking for profile information for each of the meeting participants. In some embodiments, the meeting participants may be identified by their email addresses in such a request. Mobile server 130 may process the information request, and make an API call to one or more backend databases to locate the requested information. In the alternative, it may send a data request to profiles server 132 to obtain profile information for each of the meeting participants. Profiles server 132 may in turn send a request for the requested data to profiles database 137. When the requested information is received by mobile server 130, mobile server 130 may forward the information to mobile device 110.

In the alternative, if mobile server 130 is unable to locate the requested information within enterprise network 120, mobile server 130 may send a message to mobile device 110 asking the mobile device to look up the email addresses of those meeting participants in the device contact list of mobile device 110, or in a contact list associated with the user's email account, for example, to locate information for people that mobile server 130 was not able to locate information for in enterprise network 120.

Alternatively, or in addition to the above steps, if mobile server is not able to find requested information within enterprise network 120, mobile server 130 may try to obtain information about those meeting participants from a third party service that maintains profile information. For example, it may send a request for such information to an external profiles server 150 of external network 140. External profiles server 150 may be operation by a company, such as LinkedIn, which, among other things, keeps track of profile related information for individuals.

In 262, when mobile device 110 receives requested profile information for meeting participants, in some embodiments, it may load the data into a collections view to display the data on the screen. In addition, in some embodiments, it may also copy the data into a person object associated with the meeting participant, which is stored as part of a meeting participant array that is contained in an event object for the corresponding meeting.

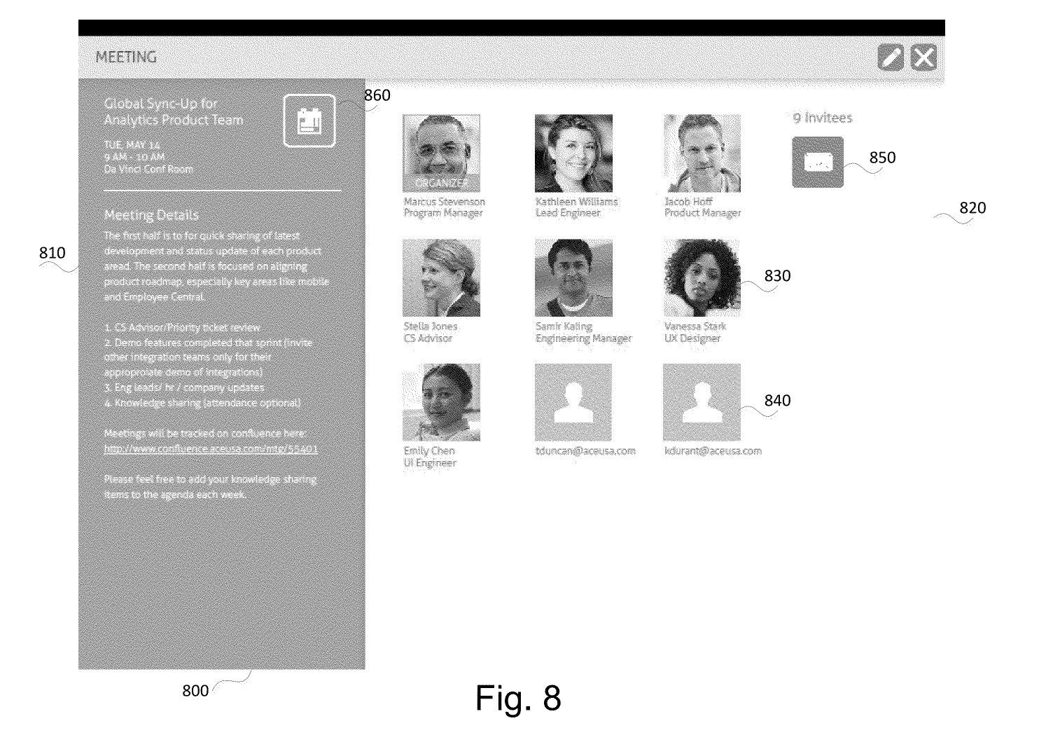

An exemplary screen 800 showing the above described more detailed event information for a selected meeting is illustrated in FIG. 8. As shown in FIG. 8, screen 800 may include two panes, a meeting participant pane 820 on the right hand side, and another pane 810 on the left hand side that includes all other meeting information. The left hand pane 810 may include information such as subject matter, date, time, location, and meeting details for the meeting. The meeting details may include, for example, an agenda.

The meeting participants' pane 820 on the right may present a display element (e.g., 830 and 840) for each meeting participant. Such meeting participant elements may include the associated individual's photograph, job title, and name. (See, e.g., 830). Where the individual is not an employee, and mobile server 130 has not been able to obtain further information about the individual from a third party that maintains profile information (e.g., LinkedIn) or a device contact list, for example, a generic shadowed head and the email address of the meeting participant, may be displayed. (See, e.g., 830).

Further, as illustrated in FIG. 8, the detailed view of a meeting with more than two participants may include an element 850 that allows a user to send an email to all meeting participants, simplifying the process for initiating such communications. The My Meeting detailed view may also include an element 860 that allows a user to access native calendar 114 of mobile device 110 directly.

In 264, it may be determined whether a user has requested second level (even more detailed) profile information regarding one of the meeting participants—second level profile information may correspond to all the information stored in connection with an employee's profile page in the enterprises profile database 137. Such a second level profile request may be made by the user manipulating an object in the GUI, for example, by double clicking on the photograph of an individual in the My Meetings detailed view. My Meetings procedure 200 may continue to wait for selection to obtain even more information regarding a selected meeting participant, in operation 264.

In 266, when an indication is received that the user wishes to obtain even more detailed information regarding one of the meeting participants, My Meetings procedure 200 may send a request to mobile server 130 to retrieve a profile page, for example, for the selected person. Mobile device 110 may transmit, for example, another API call to mobile server 130, this time using the employee identification number for the individual as the person identifying data. Steps similar to those described above in connection with obtaining the organizer's profile data, may be perform here to retrieve the profile page for the selected individual from enterprise network 120.

In 268, a profile page retrieved from backend profiles database 137 providing more detailed profile information for the selected meeting participant may be displayed. The more detailed information may include for example, the individual's job responsibilities, person they report to, etc.

Returning to step 250, if, in the alternative, it is determined that a user has selected a meeting that is a one-to-one two person meeting, a second version of a My Meetings detailed view may be provided, which, as noted above, contains information regarding touchbae topics to be discussed between the user and the other meeting participant, in addition to their profile information. This may involves a few steps.

In 270, in some embodiments, mobile server 130 may make an API call to backend database(s) 138 associated with the touchbase system of enterprise network 120 to obtain touchbase topics presently existing between the two participants to the meeting. Mobile server 130 may at the same time also send a request to profiles database 137 for information relating to the two individuals, again using an API call based on the individuals' email addresses or employee identification numbers. In some embodiments, once touchbase and profile information have been received by mobile server 130, mobile server 130 may forward the data to mobile server 110, which saves the data in an object in the events data structure, where the object corresponds to the selected event.

In 272, the retrieved profile and touchbase data may be displayed.

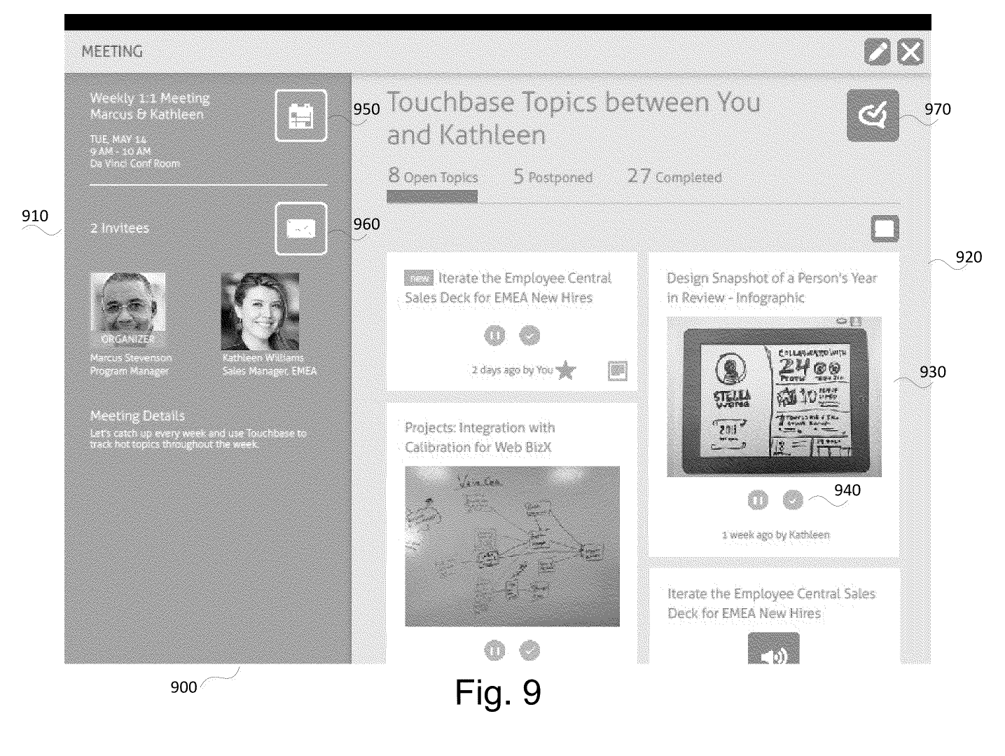

An exemplary meeting screen 900 showing a detailed view of a one-to one meeting is illustrated in FIG. 9. As shown in FIG. 9, meeting screen 900 may include two panes, a meeting participant pane 920 on the right hand side, and another pane 910 on the left hand side that includes all other meeting information. The left side pane 910 may include information such as subject matter, date, time, location, and meeting details for the meeting. The meeting details may include, for example, an agenda. The left side pane 910 may also include an icon 950 which may be manipulated by a user to directly access native calendar 114, and an icon 960 which may be manipulated by a user to launch native email application 112 to send an email to the other meeting participant. In some embodiments, the left side pane 910 may also display a photograph, job title, and name for the two participants to the meeting.

In some embodiment, in the My Meetings detailed view of a one-to-one meeting, meeting participants' pane 920 may present an element (e.g., 930) for each touchbase topic stored in the touchbase database 138 between the two individuals. Each touchbase topic may be represented in screen 900 by a screen element (e.g., a rectangular shape) that includes text describing the touchbase topic, as well as any images, audio files or other data, saved with the topic. Each touchbase topic box 930 may also include icons 940 for a user to use to indicate that a topic has been completed, or that a topic should be postponed for later use. An icon 970 may also be provided in the screen 900, which the user may manipulate in the graphical user interface to create a new touchbase topic with the other meeting participant.

In 274, it may be determined whether a user has requested to create a new touchbase topic. Such a request may be made by the user manipulating an object in the GUI, for example, by double clicking on the new topic icon 970.

In 276, when an indication is received that the user wishes to create a new touchbase topic with the other meeting participant, a pane may be displayed for the new topic on screen 900, on which the user may enter the topic. This page may contain a text field, as well as options for entering an audio or image file, for example.

In 278, My Meetings procedure 200 may retrieve any data entered by the user in the touchbase topic pane discussed with respect to operation 276. It may then send any entered data to mobile server 130 which may then in turn forward the data to touchbase server 134 for storage in touchbase database 138.

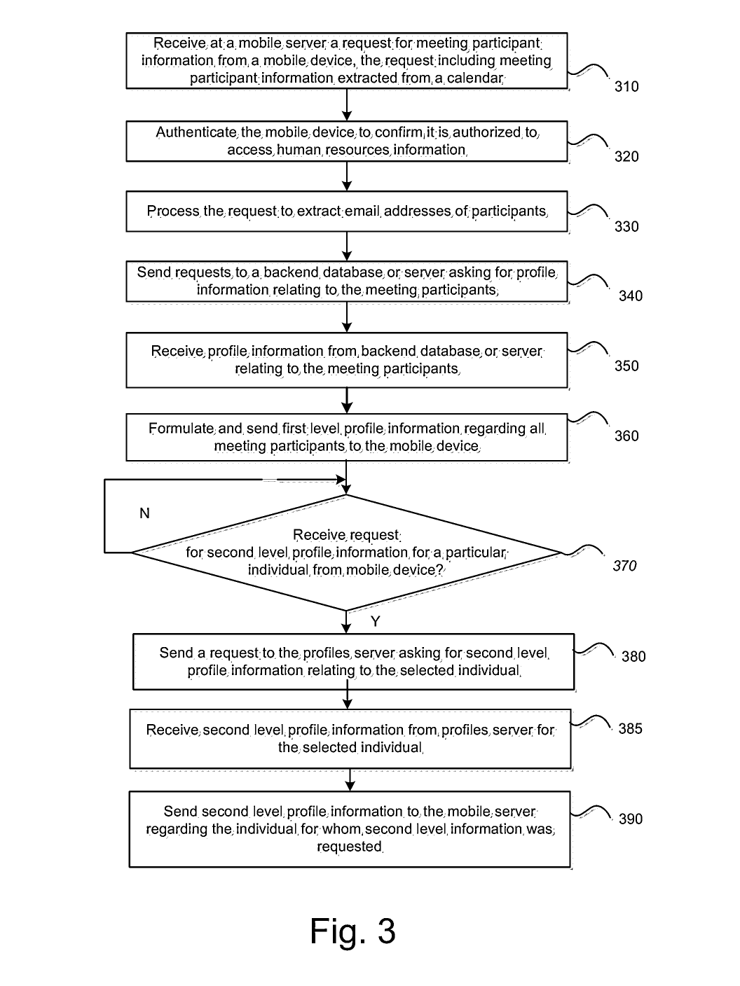

FIG. 3 is a flow diagram illustrating a procedure 300 for providing an improved daily task tool in accordance with one embodiment of the present disclosure, from the perspective of a mobile server. The improved daily task tool process 300 of FIG. 3 is described with reference to the My Meetings tool discussed above. It will be understood that, while procedure 300 is described with reference to mobile server 130 depicted in FIG. 1 for ease of description, it may be implemented on a variety of mobile servers, and network contexts.

In 310, mobile server 130 may receive a request for meeting participant information from mobile device 100, which includes identifying information concerning one or more individuals. In some embodiments, the individuals may be participants in a meeting appearing on a calendar of a user of mobile device 110, the calendar accessed on Microsoft Exchange Server or on another calendar server or service as discussed further above. In some embodiments, the identifying information may be in the form of email addresses of the individuals.

In 320, mobile device 110 may be authenticated to confirm it is authorized to access information from in enterprise network 120. In 330, the request may be processed to extract the identifying information for the individuals. The processing may involve parsing the request, for example.

In 340, requests may be sent to a backend database or server (e.g., 132 or 137) asking for profile information relating to the individuals participating in the meeting. Each request may ask for information relating to one of the individuals. In 350, in response to the requests, profile information for the individuals may be received from the backend database or server.

In 360, first level profile information regarding all individuals participating in the meeting may be formulated and sent to mobile device 110. In 379, it is determined whether a request for second level profile information for a particular individual has been received from mobile device. In some embodiments, the request for second level profile information may be indicated by the user manipulating an object in the graphical user interface of mobile device 110, for example, by double clicking on an individual's photograph.

If a request for second level profile information is received, in 380, a request to a backend database or server (e.g., 132 or 137) may be formulated and sent, asking for second level profile information relating to a selected individual. In 385, second level profile information for the selected individual may be received from the backend database or server (e.g., 132 or 137).

In 390, the second level profile information regarding the meeting participant for whom second level information was requested may be sent to the mobile server.

One challenge faced in retrieving backend data for display in a mobile device is insuring the security of the data.

Apple Inc.'s iOS Software Development Kit (SDK) provides an event data structure, which can be used for placing data in cells of a display structure, such as those related to views of the UIKit. Apple Inc. provides its own built-in hardware protection mechanism which involves setting a passcode to access the device. However, the passcode is set at the user's option; it is not mandatory.

Because personnel data retrieved from backend HCM databases may in some cases be confidential, according to some embodiments, a secure data structure is provided to hold events information.

Accordingly, the datastore provided in various embodiments provides an extra layer of security. Data is encrypted before being stored in the datastore. In some embodiments, this encryption scheme is used in conjunction with passcode protection scheme that requires authentication of users seeking to access the improved calendar 115, or the suite of business tools of which improved calendar is a part.

In creating a secure data store, however, the inventors faced the challenge that copying all the events in a user's calendar into the secure data store could be time consuming This is because a user's calendar might contain hundreds of events, and each such event might have many participants.

Therefore, a solution was developed where meetings in a user's calendar are presented in a list view that is scrolled. In some embodiments, ten days of worth of events are downloaded from the user's calendar into the secure data store, and then displayed to user. If needed, profile information may be obtained from backend databases of the enterprise's network. When a user scrolls up and down the list, more calendar data is loaded to the secure data store.

By using the user's manipulations of the scroll bar as the trigger for copying more calendar events into the secure data store, the amount of calendar events that needed to be copied into the secure data store at one time can be limited.

In various embodiments, a scroll element (e.g., element 750 in FIG. 7) appears on the screen of mobile device's graphical user interface. By manipulating scroll element 750, the user is able to determine the group of meetings that appear in the list view of calendar events at a point in time.

This mechanism shortens the time needed for copying data into the secure data store since only data relating to the limited number of events displayed in the screen at a given time need be copied into the secure data store. As noted above, according to some embodiments, when the user manipulates the user interface to scroll up or down the meeting list, at that point, additional event information may be copied into the secure data store.

FIG. 4 illustrates an exemplary secure data store 400. Secure data store 400 may include one or more data structures. According to one embodiment, secure data store 400 contains an array of event objects 420, each event object associated with a particular event—the events corresponding to events on a user's calendar. According to one embodiment, event objects 430 may include a subject matter field 450, a date field 460, a time field 470 and a location field 480. Each event object 420 may also contain a respective array 440 for holding information about the participants to the corresponding event. Each of the elements in each of the meeting participants array 440 may comprise an object associated with a particular individual who have been invited to the corresponding event. Each of the person objects in array 440 may include information such as the email address of the person, a photograph, job title, and other information regarding the person. When information is obtained from backend databases in connection with a improved daily task tool service such as the My Meetings service described in FIG. 2, the information may be stored in the secure data store with the event object corresponding to the retrieved event.

The data structures in the secure data store may be configured in a number of different ways According to some embodiments, the data structures may constitute Random Access Memory (RAM), for example. In some embodiments, the data may be stored in non-volatile data storage structures where data persists after power is turned off, such as certain kinds of flash memory, and in other embodiments, the data may be stored in volatile memory structures where the data is lost when the power is turned off, such as DRAM memory.

It is also contemplated that a variety of mechanisms could be used to store data in a created event data structure 430 associated with the My Meetings calendar, and to select appropriate data from the created events data structure 430, in order to perform improved calendar functions.

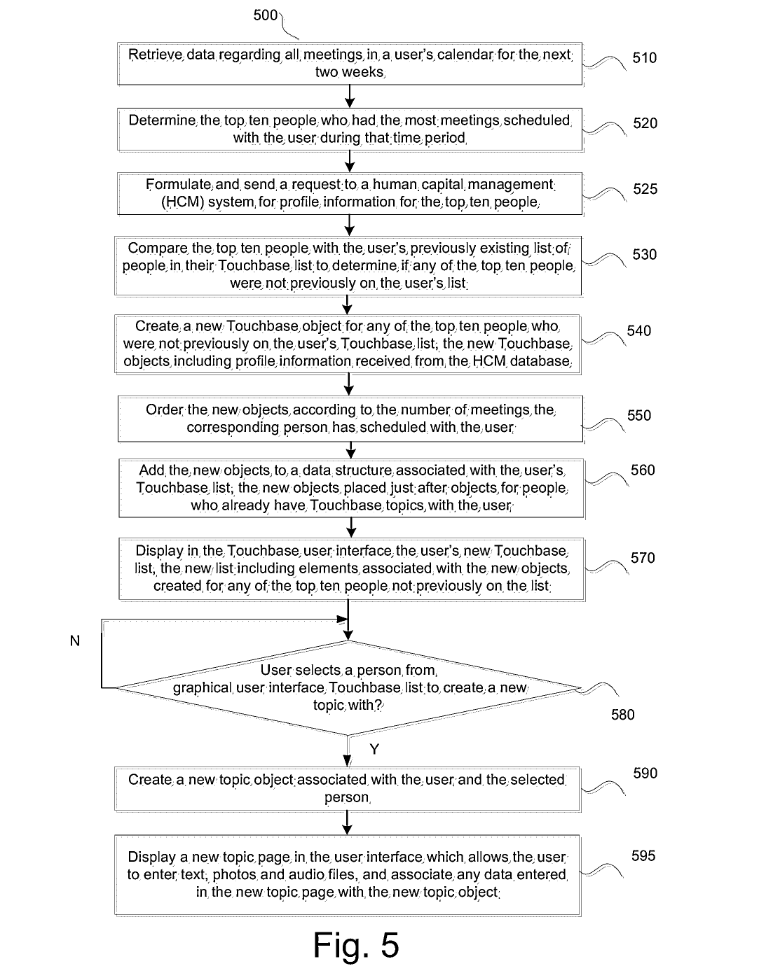

FIG. 5 is a flow diagram illustrating a procedure 500 for providing an improved touchbase daily task tool in accordance with one embodiment of the present disclosure. The improved daily task tool process 500 of FIG. 5 is described with reference to an improved tool for keeping track of discussion topics between a user and another person. An exemplary tool of this kind, as noted above, is Touchbase available from Success Factors, an SAP company based in South San Francisco, Calif. This improved touchbase tool is described with respect to a single user on a single mobile device 110. It will be understood that an improved touchbase tool may take different forms, and may be implemented with respect to any number of mobile devices, or even desk top devices such as desk top computers, and users, in a diverse cellular and/or computer network as described further below. Further, it will be understood that, while the improved touchbase tool is described with reference to mobile device 110 depicted in FIG. 1 for ease of description, it may be implemented on a variety of mobile devices.

In some embodiments, mobile device 110 may be operable to perform the below operations when application software relating to a touchbase tool is downloaded and executed on mobile device 110. In some embodiments, enterprise network 120 may include a touchbase server 134 or module responsible for storing touchbase topics, profile information and other data for a touchbase system. In addition, touchbase server 135 may also perform some or all of the functions described further below relating to determining the auto population suggestions to provide to a user.

In some embodiments, the touchbase tool may provide a user with the ability to keep track of topics she needs to discuss with a colleague. These topics may be maintained in separate topic entries. When the user logs into a touchbase system, a list view of all the persons with whom the user has created touchbase topics may be displayed. In addition, in some embodiments, the list may also be auto-populated to offer suggestions for other persons with whom it may be useful for the user to create a touchbase topic. The names auto populated into the touchbase system are provided in order to assist the user in using the tool productively. As noted above, some or all of the functionality for determining to auto populated names may be perform at a backend server 134.

For example, in some embodiments, the touchbase system may suggest a user's Manager, their direct/matrix reports, and their peers, as potential candidates for new touch base optics, and it may auto-populate those names into the user's touchbase person list. In addition, in some embodiments, further described below, auto populated suggestions for potential candidates to create a new touchbase topic with may also include individuals determined by analyzing information in a user's calendar.

This is because for some employees the above described categories of individuals may not be the most productive names to suggest to a user because sometimes the persons with whom a user has the most need to maintain touchbase topics may be individuals from other departments who may not otherwise appear to have a connection to the user in any formal manner that would be captured, for example, by an organizational chart or other system. Accordingly, in some embodiments, an improved touchbase tool is provided that has the feature that it is also autopopulated with names based on an analysis of the meetings in a user's calendar. The analysis of the user's calendar may focus on determining those individuals with whom the user has the most upcoming meetings scheduled within some predetermined time frame.

A procedure for determining and making autopopulated suggestions for persons to include in a user's touchbase list is described below. As noted above, mobile device 110 may perform the below process in conjunction with touchbase server 134, and the division of responsibility for tasks between mobile device 110 and touchbase server 134 may vary in different embodiments.

Initially, according to one embodiment, in 510, touchbase procedure 500 may retrieve data regarding all meetings in a user's calendar for the next two weeks in order to identify the top ten people who have the most meetings scheduled with the user during that time frame. This calendar information may be retrieved in any of a variety of ways discussed above for retrieving a user's calendar information. The two week period is exemplary and the time frame for which calendar information is retrieved may vary according to a user's or an administrator's preferences. In some embodiments, the process of fetching such meeting data may be triggered when the user opens the touchbase tool. Further, the process for fetching all meetings in a mobile device's local calendar for next two weeks may be performed by the touchbase application or by an application which includes a suite of daily task tools. An exemplary suite of business tools is the BizX system of business solutions available from Success Factors, a company of SAP AG based in South San Francisco, Calif.

In 520, the top ten people who had the most meetings scheduled with the user during that time period may be determined.

In 525, a request for profile information for the top ten people may be formulated and sent to mobile server 130 of enterprise network 120. Mobile server 130 may then process the request and forward a request to a touchbase server 132 or touchbase database 137 for the information.

In 530, the top ten people may be compared with the previously existing list of people in the user's touchbase list to determine which, if any, of the top ten people were not previously on the user's list.

In 540, a new touchbase object may be created for any of the top ten people who were not previously on the user's touchbase list, the new touchbase objects including profile information received from the touchbase database 138.

In 550, the new objects may be ordered according to the number of meetings the corresponding person has scheduled with the user.

In 560, the new objects may be added to a data structure associated with the user's touchbase list, the new objects placed adjacent to objects for people who already have touchbase topics with the user.

In 570, the user's new touchbase list may be displayed in a touchbase screen of a graphical user interface of mobile device 110, the new list including the names of any of the top ten people who were not previously on the touchbase user list. For each person named on the list, the touchbase tool may display profile information such as full name, title, and/or photograph, for example.

In 580, it may be determined whether a user has selected a person to create a new topic with, from the user touchbase list of person displayed in the interactive graphical user interface of mobile device 110.

In 590, a new topic object associated with the user and the selected person, may be created.

In 595 a new topic pane may be displayed which allows the user to enter text, photos and audio files, and associate any data entered in the new topic page with the new topic object. Such new topic pane may be displayed by mobile device 110 in its user interface. Subsequently, any text, images, audio files entered by the user on touchbase topic pane may be associated with the touchbase topic by mobile device 110 and sent to touchbase server 134 in enterprise network 120.

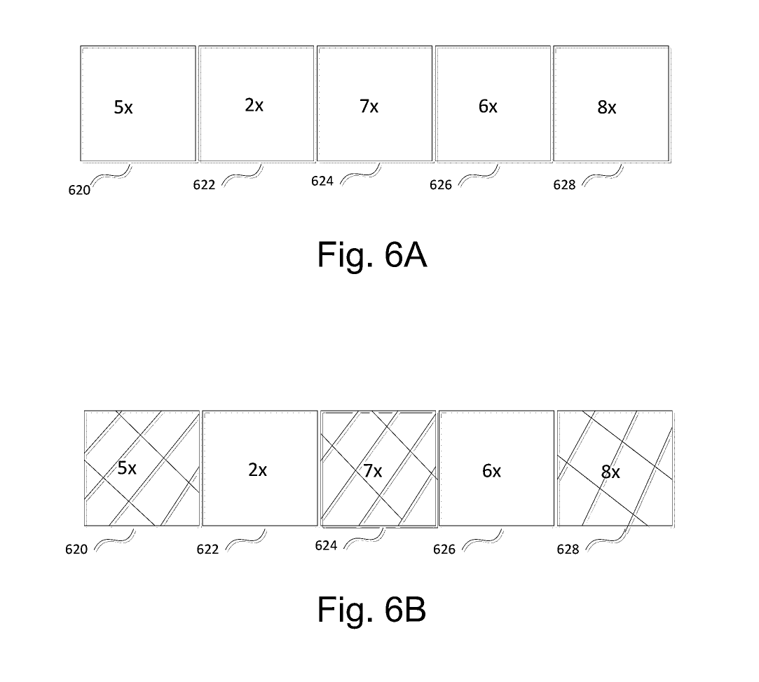

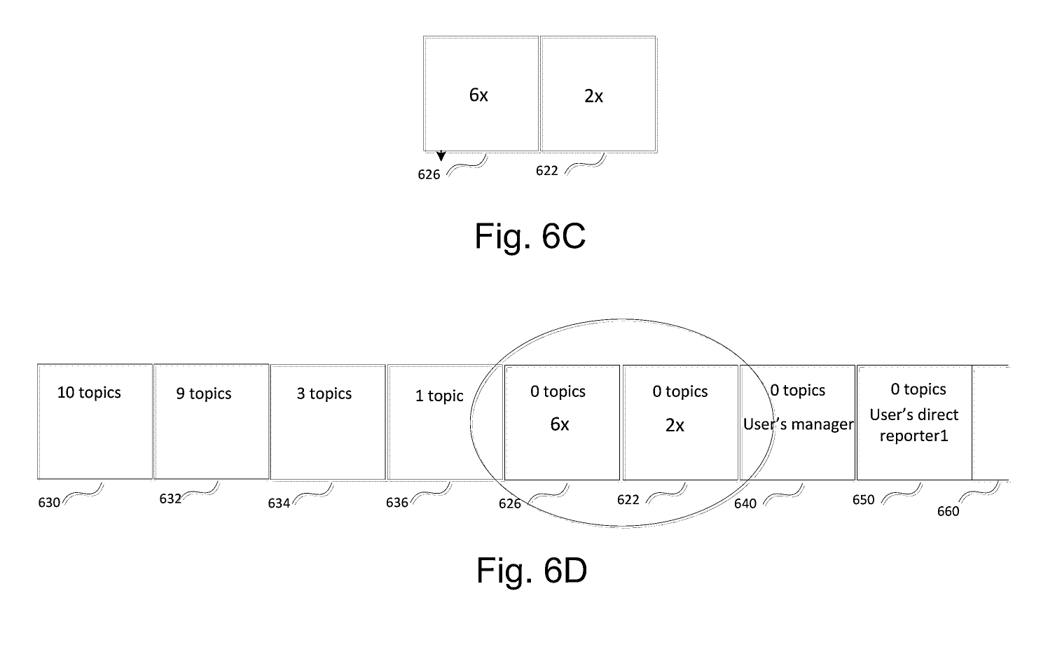

FIGS. 6A-6D are diagrams illustrating the process of merging and ordering described above with respect to FIG. 5. In FIG. 6A, in this example, the top five persons with the most meetings with the user in the next two weeks are identified. The boxes 620, 622, 624, 626, and 628 in FIG. 6A represent data structures associated with those five persons, with the numbers (for example, 5×, and 2×) in the boxes representing the number of meetings the associated person has scheduled with the user within the next two weeks.

FIG. 6B represents the results of merging the list of top five people with the preexisting list of persons with whom the user has touchbase topics. As the user already has touchbase topics with these individuals, those persons will already show on the user's touchbase list and there is no need for an autopopulated suggestion regarding these persons, so the data objects (e.g., 620, 624, and 628) associated with those person are eliminated from the group of persons with whom the process proceeds.

In this example, after the elimination of the people previously existing on the user's touchbase list of person, only the persons corresponding to boxes 622 and 626 are left. Next, the remaining persons of the top five persons are reordered in order of how many meetings they have scheduled with the user in the next two weeks.

FIG. 6C illustrates the result of that reordering operation.

Next, the data objects 622 and 626 associated with the remaining persons of the top five list are added to an array which is responsible for holding objects associated with each of the persons in the user's touchbase list of persons. The persons in the user's touchbase list—and thus the objects in the touchbase array—are ordered according to the number of touchbase topics the user has with the person. Thus, the auto populated new objects based on the analysis of the user's calendar are placed after all the object 630. 632, 634 and 636 associated with persons with whom the user actually had preexisting touchbase topics.

A view of the resulting array of objects is illustrated in FIG. 6D. In FIG. 6D, the objects 626 and 622 associated with the remaining persons from the top five list are circled to highlight them. Note that objects 626 and 622 are located in the array just after the objects associated with the people who already had touchbase topics with the user, and that following the circled objects 626 and 622 in the array are an object associated with the user's manager (at 640) and an object associated with a first of the user's direct reports (at 650).

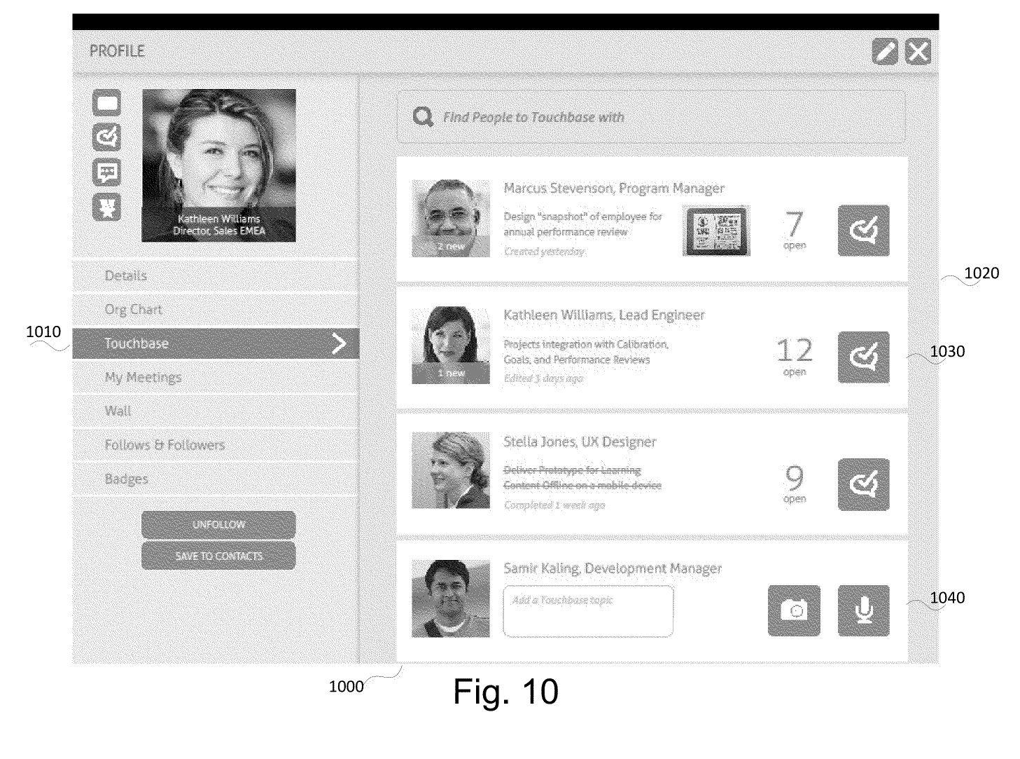

FIG. 10 illustrates an exemplary screen 1000 of a graphical user interface of mobile device 110 that shows a user's touchbase list of persons that may result from the operations described above with respect to FIG. 5.

As illustrated, the list may include persons with whom the user already has touchbase topics, as well as persons for whom the touchbase application has provided autopopolated suggestions for persons with whom the user may wish to create future touchbase topics.

As shown in FIG. 10, an option 1010 may be provided, which the user may select to open a touchbase pane 1020 on the screen 1000. When the user selects that option, a touchbase list of persons may appear in a touchbase pane 1020 of screen 1000.

Touchbase pane 1020 may include entries such as entry 1030 for persons with whom the user already has touchbase topics. In addition, touchbase pane 1020, as illustrated in FIG. 10, may also include persons (such as the person identified in entry 1040) with whom the user presently has no touchbase topics but with whom the touchbase system is suggesting the user may wish to consider creating a touchbase topic.

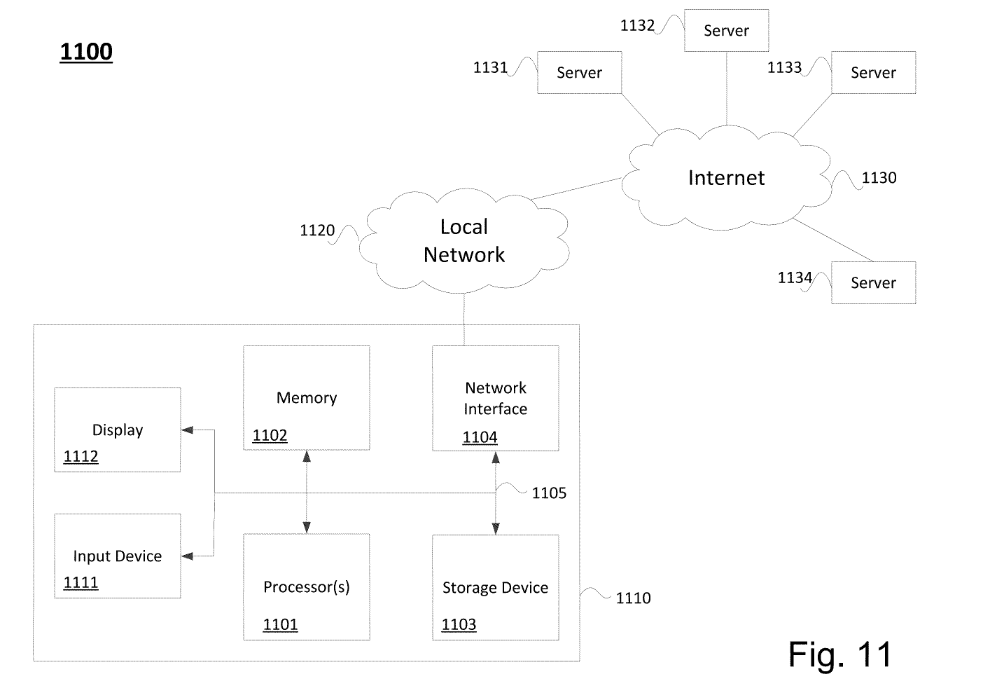

FIG. 11 illustrates hardware of a special purpose computing machine configured with a process according to the above disclosure. The following hardware description is merely one example. It is to be understood that a variety of computers topologies may be used to implement the above described techniques. An example computer system 1110 is illustrated in FIG. 11. Computer system 1110 includes a bus 1105 or other communication mechanism for communicating information, and one or more processor(s) 1101 coupled with bus 1105 for processing information. One or more processor(s) 1101 may take various forms including microcontrollers and microprocessors such as programmable devices (e.g., CPLDs and FPGAs) and unprogrammable devices such as gate array ASICs or general purpose microprocessors. Computer system 1110 also includes a memory 1102 coupled to bus 1105 for storing information and instructions to be executed by processor 1101, including information and instructions for performing some of the techniques described above, for example. This memory may also be used for storing programs executed by processor 1101. Memory 1102 may comprise a single or multiple storage components or devices. Possible implementations of this memory may be, but are not limited to, random access memory (RAM), read only memory (ROM), or both. A storage device 1103 is also provided for storing information and instructions. Common forms of storage devices include, for example, a hard drive, a magnetic disk, an optical disk, a CD-ROM, a DVD, a flash or other non-volatile memory, a USB memory card, or any other medium from which a computer can read. Storage device 1103 may include source code, binary code, or software files for performing the techniques above, for example. Storage device and memory may both include any suitable non-transitory computer-readable media such as those described herein. Memory 1102 and storage device 1103 may comprise a single or multiple memory or storage components or devices, respectively.

Computer system 1110 may be coupled via bus 1105 to an output device 1112 for providing information to a computer user. Output device 1112 may take the form of a display or speakers, for example. An input device 1111 such as a keyboard, touchscreen, mouse, and/or microphone, may be coupled to bus 1105 for communicating information and command selections from the user to processor 1101. The combination of these components allows the user to communicate with the system. In some systems, bus 1105 may represent multiple specialized buses, for example.

Computer system 1110 also includes a network interface 1104 coupled with bus 1105. Network interface 1104 may provide two-way data communication between computer system 1110 and a local network 1120. The network interface 1104 may be a wireless or wired connection, for example. Computer system 1110 may send and receive information through the network interface 1104 across a local area network, an Intranet, a cellular network, or the Internet, for example. One example implementation may include computing system 1110 acting as a mobile server that receives requests for data from a mobile server and retrieves data stored in backend databases in response to the requests received from the mobile server, and forwards the data to the mobile server. Another example implementation may include computing system 1110 acting as touchbase server that analyzes events on a user's calendar to determine auto populated entries to include in a touchbase list, the auto populated entries reflecting persons with whom a touchbase user may wish to create a touchbase entry. In the Internet example, computing system 1110 may be accessed by the mobile devices through a wireless connection to the Internet, for example, and computing system 1110 may access data and features on backend systems that may reside on multiple different hardware servers 1131-1135 across the network. Servers 1131-1135 and server applications may also reside in a cloud computing environment, for example. Various embodiments may be practiced in a wide variety of network environments including, for example, TCP/IP-based networks, telecommunications networks, cellular communications networks, wireless networks, etc., or combinations of different network types.

As noted above, the apparatuses, methods, and techniques described below may be implemented as a computer program (software) executing on one or more computers. The computer program may further be stored on a tangible non-transitory computer readable medium, such as a memory or disk, for example. A computer readable medium may include instructions for performing the processes described herein. Examples of such computer readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM).

In addition, the computer program instructions with which various embodiments of this disclosure are implemented may be executed according to a variety of computing models including a client/server model, a peer-to-peer model, on a stand-alone computing device, or according to a distributed computing model in which various functions described herein may be performed at different locations.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed:

1. A method comprising:
receiving, at a computing device, calendar data regarding a user's calendar;
processing, at the computing device, the calendar data to identify events on the user's calendar;
displaying, at the computing device, a first view of a plurality of the events on a graphical user interface of the computing device;
receiving, at the computing device, an indication that the user has selected a first event from the plurality of events; and
replacing, at the computing device, the first view of the plurality of events with a second view of one or more events on the user's calendar, wherein the second view highlights the selected event, and wherein the second view provides further information about the selected event based on data retrieved from one or more backend databases of an enterprise network.

2. The method of claim 1, further comprising:
receiving an indication that the user has requested more detailed information regarding event participants of the selected first event, the event participants comprising each organizer and each invitee of the selected event.

3. The method of claim 2, further comprising
sending a request to a gateway device of enterprise network to retrieve profile data regarding each event participant;
displaying profile data for each of the event participants in the graphical user interface, the profile data received from the enterprise network.

4. The method of claim 3, further comprising:
receiving an indication that the user has requested second level profile data regarding a selected person of the event participants of the selected event;
sending a request to the gateway device of the enterprise network to retrieve second level profile data regarding the selected person;
displaying received second level profile data associated with the selected person in the graphical user interface.

5. The method of claim 1, wherein it is determined that the selected event is a two person meeting, the method further comprising
sending a request to the gateway device of the enterprise network to retrieve data regarding touchbase topics between the two meeting participants;
displaying received touchbase topics in the graphical user interfade.

6. The method of claim 5,
determining that the user has made a selection indicating that the user wishes to create a new touchbase topic with the selected person.
displaying a touchbase pane on the graphical user interface for user to enter a new topic;
retrieving any data entered by user on the touchbase pane; and
sending the data to the enterprise network to store on a touchbase database of the enterprise network.

7. The method of claim 1, wherein a scroll bar is presented in the first view of the plurality of events, and wherein the graphical user interface is operable such that a user by manipulating the scroll bar is able to determine a subset of the plurality of events to be displayed in the graphical user interface.

8. The method of claim 1, wherein data retrieved from the enterprise network is encrypted and stored in a secure data store.

9. A computer system comprising:
one or more processors; and
a non-transitory computer readable medium having stored thereon one or more programs, which when executed by the one or more processors, causes the one or more processor to singly or in combination:
receive calendar data regarding a user's calendar;
process the calendar data to identify events on the user's calendar;
display a first view of a plurality of the events on a graphical user interface of the computing device;
receive an indication that the user has selected a first event from the plurality of events; and
replace the first view of the plurality of events with a second view of one or more events on the user's calendar, wherein the second view highlights the selected event, and wherein the second view provides further information about the selected event based at least in part on data retrieved from one or more backend databases of an enterprise network.

10. The computer system of claim 9, wherein the non-transitory computer readable medium when executed by the one or more processes further causes the one or more processor to singly or in combination receive an indication that the user has requested more detailed information regarding event participants of the selected first event, the event participants comprising each organizer and each invitee of the selected event.

11. The computer system of claim 10, wherein the non-transitory computer readable medium when executed by the one or more processes further causes the one or more processor to singly or in combination:
send a request to a gateway device of enterprise network to retrieve profile data regarding each event participant; and
display profile data for each of the event participants in the graphical user interface, the profile data received from the enterprise network.

12. The computer system of claim 11, wherein the non-transitory computer readable medium when executed by the one or more processes further causes the one or more processor to singly or in combination:
receive an indication that the user has requested second level profile data regarding a selected person of the event participants of the selected event;
send a request to the gateway device of the enterprise network to retrieve second level profile data regarding the selected person;
display received second level profile data associated with the selected person in the graphical user interface.

13. The computer system of claim 9, wherein it is determined that the selected event is a two person meeting, and wherein the non-transitory computer readable medium when executed by the one or more processes further causes the one or more processor to singly or in combination:
send a request to the gateway device of the enterprise network to retrieve data regarding touchbase topics between the two meeting participants; and
display received touchbase topics in the graphical user interface.

14. The computer system of claim 13, wherein the non-transitory computer readable medium when executed by the one or more processes further causes the one or more processor to singly or in combination:
determine that the user has made a selection indicating that the user wishes to create a new touchbase topic with the selected person.
display a touchbase pane on the graphical user interface for user to enter a new topic;
retrieve any data entered by user on the touchbase pane; and
send the entered data to the enterprise network to store on a touchbase database of the enterprise network.

15. The computer system of claim 9, wherein a scroll bar is presented in the first view of the plurality of events, and wherein the graphical user interface is operable such that a user by manipulating the scroll bar is able to determine a subset of the plurality of events to be displayed in the graphical user interface.

16. The computer system of claim 9, wherein data retrieved from the enterprise network is encrypted and stored in a secure data store.

17. A non-transitory computer readable storage medium storing one or more programs, the one or more programs comprising instructions for:
receiving, at a computing device, calendar data regarding a user's calendar;
processing, at the computing device, the calendar data to identify events on the user's calendar;
displaying, at the computing device, a first view of a plurality of the events on a graphical user interface of the computing device;
receiving, at the computing device, an indication that the user has selected a first event from the plurality of events; and
replacing, at the computing device, the first view of the plurality of events with a second view of one or more events on the user's calendar, wherein the second view highlights the selected event, and wherein the second view provides further information about the selected event based at least in part on data retrieved from one or more backend databases of an enterprise network.

18. The non-transitory computer readable storage medium of claim 17, the one or more programs further comprising instructions for:
receiving an indication that the user has requested more detailed information regarding event participants of the selected first event, the event participants comprising each organizer and each invitee of the selected event.
sending a request to a gateway device of enterprise network to retrieve profile data regarding each event participant; and
displaying profile data for each of the event participants in the graphical user interface, the profile data received from the enterprise network.

19. The non-transitory computer readable storage medium of claim 17, the one or more programs further comprising instructions for:
sending a request to the gateway device of the enterprise network to retrieve data regarding touchbase topics between the two meeting participants;
displaying received touchbase topics in the graphical user interface.

20. The non-transitory computer readable storage medium of claim 17, wherein a scroll bar is presented in the first view of the plurality of events, and wherein the graphical user interface is operable such that a user by manipulating the scroll bar is able to determine a subset of the plurality of events to be displayed in the graphical user interface; and
wherein data retrieved from the enterprise network is encrypted and stored in a secure data store.
